(19) United States
(12) Patent Application Publication
(10) Pub. No.: US 2010/0154283 A1
(43) Pub. Date: Jun. 24, 2010

(54) FEATHERED DUCK DECOY SKIRT

(76) Inventors: John Fischer, Marietta, GA (US); Whitfield Smith, Dallas, TX (US)

Correspondence Address: John Fischer, 1948 Miniball Ridge, Marietta, GA, 30064, US

(21) Appl. No.: 12/642,839

(22) Filed: Dec. 20, 2009

Related U.S. Application Data
(60) Provisional application No. 61/203,201, filed on Dec. 20, 2008.

(51) Int. Cl. A01M 31/06

(52) U.S. Cl. 43/3; 43/2

(57) ABSTRACT

A feathered skirt that fits over hunting duck decoys to create a more realistic looking hunting duck decoy. The feathered skirt includes a plastic material wrap around skirt having simulated and/or real duck feathers. The plastic skirt is a thin plastic waterproof material which wraps around a duck decoy. The simulated and/or real duck feathers on the skirt resemble either a male drake or female hen of the mallard species.

### REFERENCE TO RELATED APPLICATIONS

This patent application claims the benefit of U.S. Provisional Application No. 61/203,201 filed on Dec. 20, 2008, the disclosure of which is incorporated herein by reference in its entirety.

### BACKGROUND OF THE INVENTION

1. Field of the Invention

The present invention relates generally to Mallard duck decoys and more particularly to a feathered skirt that fits over a hunting duck decoy to create a duck decoy which more realistically looks like a true to life hunting duck decoy.

2. Description of Related Art

It can be appreciated that duck decoys have been in use for years. Typically, duck decoys are composed of painted plastic material duck molds.

The main problem with prior art duck decoys is that they look more like decoys than real ducks. Another problem with prior art duck decoys is that they are easily detected as decoys by live ducks.

In prior art embodiments there is disclosed outer coverings that have simulated and real feathers which are attached to a decoy with Velcro type fastening means. Outer coverings for decoys are disclosed, for example, in
U.S. Pat. No. 4,691,464
Inventor: Rudolph
Issued: Sep. 8, 1987

This patent discloses a flexible fabric covering for avian decoys for enhancing the life-like accuracy of the decoy. Markings are illustrated on the exterior of the covering and represent the surface features of a wildfowl. A reflective iridescent panel is attached to the covering at substantially the location of a duck's secondary feathers to mimic the iridescence of the secondary feathers. The covering is removably secured to the decoy by a drawstring or elastic band.
U.S. Pat. No. 6,092,322
Inventor: Samaras
Issued: Jul. 25, 2000

This patent discloses the simulation of moving feathers on the torso of a fowl which may be made to “strut” or stand up preferably through the Use of sheet plastic, which can be blown up by wind to add a more realistic appearance to a decoy thereby being more attractive to turkeys.
U.S. PreGrant Pub. No. 2007/0199228
Inventor: Johnson
Published: Aug. 30, 2007

A decoy with a surface reflection which closely matches the spectral reflectance of the animal or object that it is designed to mimic, including both human-visible and ultraviolet wavelengths, with the intent of making the decoy appear more realistic to animals who can see in both the human-visible and ultraviolet spectrums.
U.S.PreGrant Pub. No. 2008/0034639
Inventor: Abbas
Published: Feb. 14, 2008

A decoy cover and a decoy that has the decoy cover and consists of, in one embodiment, simulated feathers and in another embodiment, real feathers. The cover is easily attachable and removable. The near end of the covering is placed around the head portion of the outer casing of a decoy and the distal end attaches around the tail portion. There is a strap around the middle section that secures the outer casing to the main body housing. In the first embodiment, there are at least two rod extensions that originate from the main body that pass through the outer covering extending outwardly, with simulated feathers attached at the end. The feathers that are attached to the end can move even in the gentlest breeze creating the appearance of movement of the fowl.

What is needed is a feathered duck decoy skirt that has an openings at one end to enable the device to fit over the head of a duck decoy and encase the decoy with feathers. This is facilitated by utilizing an endless loop elastic member for quickly and easily attaching the skirt to said duck decoy.

### SUMMARY OF THE INVENTION

It is an object of the invention to provide a feathered duck skirt that can be quickly and easily attached to a duck decoy.

It is another object of the invention to provide a feathered duck skirt that can create a more realistic looking duck decoy.

It is another object of the invention to provide a removable duck skirt that enhances a normal decoy to appear more life like.

It is another object of the invention to provide a feathered duck skirt that attracts live ducks.

In is another object of the invention to provide a feathered duck skirt that is viewed as a live duck and not as a decoy when floating in water.

It is another object of the invention to provide a feathered duck skirt that assist hunters in attracting ducks.

In an exemplary embodiment of the present invention, there is disclosed a decoy skirt, said skirt comprising;
a main body having a first end and a second end;
an endless loop of elastic material located around the edge of the main body adapted to be placed around the body of a decoy to attach the main body to the decoy; and
an opening at the first end of the main body;
wherein said opening is defined by a segment of the endless loop of elastic material and the first end of the main body.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals.

FIG. 1 shows a removable feathered duck decoy skirt of a mallard hen on a duck decoy in accordance with the principles of the invention;

FIG. 2 shows a removable feathered duck decoy skirt of a mallard drake on a duck decoy in accordance with the principles of the invention; and

FIG. 3 shows the removable feathered duct decoy skirt having an opening for the head of the decoy and an endless elastic loop around the edge of the skirt for attaching the skirt to the body of a decoy in accordance with the principles of the invention.

### DESCRIPTION OF THE PREFERRED EMBODIMENT

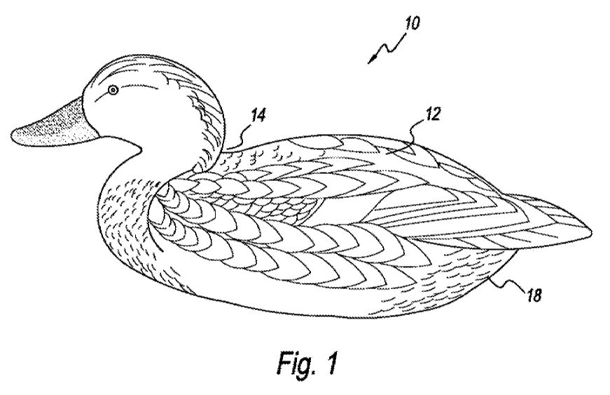

Referring to FIG. 1, there is shown a view of a mallard hen 10 with a removable feathered mallard hen skirt 12 in accordance with the principles of the invention. A duck decoy is usually placed on a lake or pond floating upon the water. Before placing the duck decoy into its floating position, an opening 14 in the main body of the skirt is placed around the head of the decoy. Then, an endless loop of elastic material 18 that is located around the edge of the skirt is placed around the body of the duck decoy to secure the skirt to the decoy. The opening in the main body of the skirt is defined by a first end of the main body of the skirt and a first segment of the endless loop of elastic material.

The duck decoy skirt 12 is made of a fabric or a plastic material which functions as a support member for either simulated duck feathers, real duck feathers, or a combination of simulated and real duck feathers.

The plastic material skirt is composed of a thin plastic waterproof material which wraps easily around the decoy and is attached to the decoy with the endless elastic band of material. The simulated duck feathers shown in FIG. 1 are of a female hen of the mallard species. The skirt with the thin plastic material and the endless elastic band of material is similar to a shower cap, and which fits snugly around the body of a duck decoy.

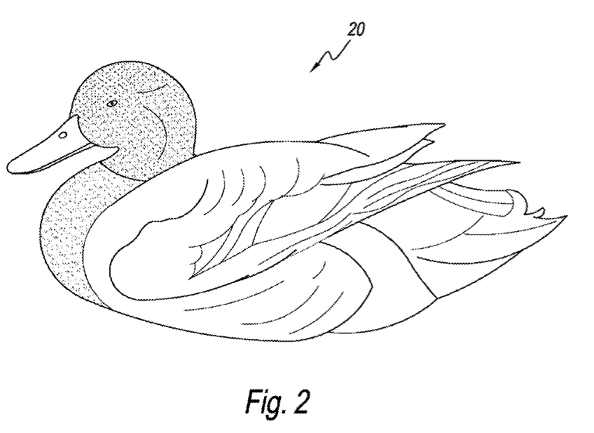

Referring to FIG. 2, there is shown a removable feathered duck decoy skirt of a mallard drake 20 on a duck decoy in accordance with the principles of the invention. The duck feathers resemble that of a male drake of the mallard species. The feathers can be real, synthetic or artificial.

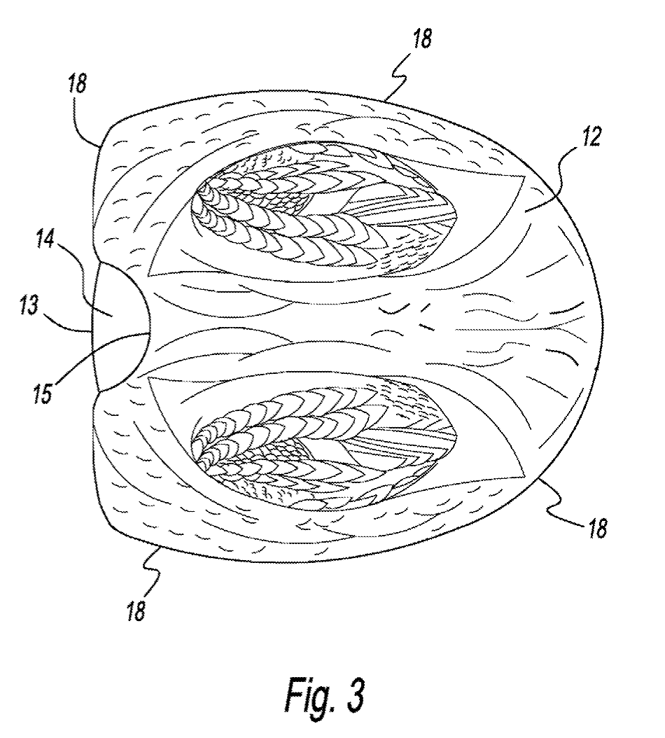

Referring to FIG. 3, there is shown the removable feathered duck decoy skirt having an openings for the head of the decoy and the endless elastic loop band of material located around the edge of the skirt for attaching the skirt to a decoy. The skirt has an opening 14 which is placed around the head of the decoy. Then, the endless loop of elastic material 18 that is located along the edge and completely surrounds the skirt 12 is placed around the body of the duck decoy to secure the skirt to the decoy. The elastic material 18 functions by enclosing itself firmly around the underbelly of the duck decoy and therein acts to keep said skirt securely attached to the decoy. Thus, opening 14 in the skirt is defined by a first end 15 of the skirt and a first segment 13 of the endless loop of elastic material.

The duck decoy skirt 12 is made of a thin plastic material which functions as a support member for either simulated duck feathers, real duck feathers or a combination of simulated and real duck feathers.

The material skirt is made of a thin plastic or waterproof fabric material which wraps easily around the top and sides of the decoy and is attached to the decoy with the endless elastic band of material. The duck decoy with artificial and/or real feathers shown in FIG. 1 is of a female hen of the mallard species. The skirt with the thin plastic material and the endless elastic band of material is similar to a shower cap, and fits snugly around the lower sides of a duck decoy to securely attach the skirt to a decoy. The feathers are attached to the plastic skirt with a waterproof glue such as an epoxy in a manner which closely resembles a mallard drake or mallard hen. The feathers can be attached using an epoxy type of glue, spray mount, or punctured thru the plastic cover and glued in place.

The feathered duck skirt enhances the appearance of a duck decoy by making it appear more lifelike. The feathers on the decoy duck are actual feathers, either artificial and/or real which can move with the slightest wind to provide a realism that is not present with molded prior art decoys. The simulated and artificial feathers can be made from a plastic, cloth, or any other suitable waterproof material.

With respect to the above description, it is to be realized that the optimum dimensional relationships for the parts of the skirt, which include variations in size, materials, shape, form, function and manner of operation, assembly and use , are deemed readily apparent and obvious to one skilled in the art, and all equivalent relationships to those illustrated in the drawings and described in the specification are intended to be encompassed by the present invention.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A decoy skirt, said skirt comprising;
a main body having a first end and a second end;
an endless loop of elastic material located around the edge of the main body adapted to be placed around the body of a decoy to attach the main body to the decoy; and
an opening at the first end of the main body;
wherein said opening is defined by a first segment of the endless loop of elastic material and the first end of the main body.

2. The skirt of claim 1 wherein said main body is composed of a plastic or a fabric.

3. The skirt of claim 2 further comprising feathers attached to the main body.

4. The skirt of claim 3 wherein said feathers are simulated feathers made of a waterproof material.

5. The skirt of claim 3 wherein said simulated feathers are attached with a waterproof adhesive.

6. The skirt of claim 5 wherein said simulated feathers are made of a plastic.

7. The skirt of claim 3 wherein said feathers are real feathers.

8. The skirt of claim 7 wherein said real feathers are attached with a waterproof adhesive.

9. The skirt of claim 3 wherein said feathers are simulated feathers and real feathers.

10. The skirt of claim 9 wherein said simulate and real feathers are attached to said main body with a waterproof adhesive.

11. The skirt of claim 10 wherein said waterproof adhesive is an epoxy.

12. A decoy having the skirt of claim 1.

13. The decoy of claim 12 wherein said decoy is a mallard duck.

14. The decoy of claim 13 wherein said opening is adapted to be located around the neck of the mallard duck decoy.

15. The decoy of claim 12 wherein said decoy is a male drake of the mallard species.

16. The decoy of claim 12 wherein said decoy is a female hen of the mallard species.

17. The skirt of claim 3 wherein said feathers are attached to the surface of the main body.

18. (canceled)
